(19) United States
(12) Patent Application Publication
(10) Pub. No.: US 2018/0285802 A1
(43) Pub. Date: Oct. 4, 2018

(54) TRACKING ASSOCIATE INTERACTION

(71) Applicant: Walmart Apollo, LLC, Bentonville, AR (US)

(72) Inventors: Steven Lewis, Bentonville, AR (US); Nicholaus Adam Jones, Fayetteville, AR (US); Matthew Dwain Biermann, Fayetteville, AR (US)

(21) Appl. No.: 15/941,475

(22) Filed: Mar. 30, 2018

Related U.S. Application Data
(60) Provisional application No. 62/481,464, filed on Apr. 4, 2017.

(51) Int. Cl. G06Q 10/06; G06Q 30/02

(52) U.S. Cl. CPC G06Q 10/06393; G06Q 10/06398; G06Q 30/0281

(57) ABSTRACT

Methods and systems for tracking associate interaction with a customer are described. A method may include receiving, at an associate-customer interaction server, associate action data from an electronic sensor. The method may further include determining, at the associate-customer interaction server and from the associate action data received from the electronic sensor, whether an interaction between an associate and a customer has been initiated. The method may also include, in response to determining that the interaction between the associate and the customer has been initiated, determining, at the associate-customer interaction server, whether the associate acted in accordance with an electronically defined associate-customer interaction policy during the interaction based on the associate action data. The method may additionally include, in response to determining that the associate acted in accordance with the electronically defined associate-customer interaction policy, assigning, via the associate-customer interaction server, credit to a customer interaction electronic record.

### RELATED APPLICATIONS

This application claims the benefit of U.S. Provisional Patent Application No. 62/481,464, filed Apr. 4, 2017 and entitled “Tracking Associate Interaction”, the contents of which are incorporated herein in their entirety.

### TECHNICAL FIELD

The technical field may generally relate to tracking associate interaction, and more particularly to tracking associate interaction with a customer in a retail store setting.

### BACKGROUND

A company or business may have multiple employees and may wish to track performance of those employees in different settings. For example, the customer or business may be a retailer that sells goods to customers at a physical store. The retailer may have employees or associates who work at the physical store to stock the store shelfs, receive payment from customers, or assist customers shopping at the store, among other tasks. The retailer may instruct associates to interact with customers in various situations and circumstances. The retailer may also wish to understand more about how associates interact with customers and whether or not the associates follow the retailer's policies while interacting with customers.

### BRIEF SUMMARY

In an embodiment, a method for tracking associate interaction with a customer may include receiving, at an associate-customer interaction server, associate action data from an electronic sensor. The method may further include determining, at the associate-customer interaction server and from the associate action data received from the electronic sensor, whether an interaction between an associate and a customer has been initiated. The method may also include, in response to determining that the interaction between the associate and the customer has been initiated, determining, at the associate-customer interaction server, whether the associate acted in accordance with an electronically defined associate-customer interaction policy during the interaction based on the associate action data. The method may additionally include, in response to determining that the associate acted in accordance with the electronically defined associate-customer interaction policy, assigning, via the associate-customer interaction server, credit to a customer interaction electronic record corresponding to the associate.

In an implementation, the electronic sensor may be a component of a mobile device corresponding to the associate. The electronic sensor may be at least one of an accelerometer, a microphone, a video camera, an audio recorder, a Wi-Fi transceiver, a Bluetooth transceiver, an NFC transceiver, a GPS transceiver, and a telecommunications transceiver. Determining whether the interaction between the associate and the customer has been initiated may include determining whether the associate came within an electronically predefined distance of the customer based on the associate action data received from the electronic sensor. Determining whether the associate acted in accordance with the electronically defined associate-customer interaction policy during the interaction may include determining whether the associate greeted the customer based on the associate action data received from the electronic sensor, determining whether the associate smiled at the customer based on the associate action data received from the electronic sensor; and/or determining whether the associate said hello to the customer based on the associate action data received from the electronic sensor.

In an implementation, determining whether the associate acted in accordance with the electronically defined associate-customer interaction policy during the interaction may include determining whether the associate shook the customer's hand based on the associate action data received from the electronic sensor or determining whether the associate lead the customer to a product based on the associate action data received from the electronic sensor. Determining whether the interaction between the associate and the customer has been initiated may include determining whether the associate deviated from an electronically defined associate task list based on the associate action data received from the electronic sensor and determining whether the associate left a particular area associated with the electronically defined associate task list based on the associate action data received from the electronic sensor.

In an implementation, the method may include determining if the customer interaction electronic record corresponding to the associate has reached a threshold credit level and, in response to determining that the customer interaction electronic record corresponding to the associate has reached a threshold credit level, assigning a reward to the associate. The method may further include, in response to determining that the associate acted in accordance with the electronically defined associate-customer interaction policy, transmitting a command to provide a tactile feedback to the associate. The command to provide the tactile feedback to the associate may be a command to actuate a vibration in a mobile device corresponding to the associate. Determining whether the interaction between the associate and the customer has been initiated may be based on location based-data from at least one of a mobile device corresponding to the associate and a mobile device corresponding to the customer. The location based-data may be based on a Wi-Fi connection of at least one of the mobile device corresponding to the associate and the mobile device corresponding to the customer.

In an embodiment, a system for tracking associate interaction with a customer may include an associate-customer interaction server configured to receive associate action data from an electronic sensor. The associate-customer interaction server may be further configured to determine, from the associate action data received from the electronic sensor, whether an interaction between an associate and a customer has been initiated. The associate-customer interaction server may also be configured to, in response to determining that the interaction between the associate and the customer has been initiated, determine, from the associate action data received from the electronic sensor, whether the associate acted in accordance with an electronically defined associate-customer interaction policy during the interaction. The associate-customer interaction server may additionally be configured to in response to determining that the associate acted in accordance with the electronically defined associate-customer interaction policy, assign credit to a customer interaction electronic record corresponding to the associate.

In an implementation, the electronic sensor may be a component of a mobile device corresponding to the associate. The electronic sensor may be at least one of an accelerometer, a microphone, a video camera, an audio recorder, a Wi-Fi transceiver, a Bluetooth transceiver, an NFC transceiver, a GPS transceiver, and a telecommunications transceiver. The associate-customer interaction server may be configured to determine whether the associate came within an electronically predefined distance of the customer based on the associate action data received from the electronic sensor. The associate-customer interaction server may be further configured to determine whether the associate greeted the customer based on the associate action data received from the electronic sensor, determine whether the associate smiled at the customer based on the associate action data received from the electronic sensor, and/or determine whether the associate said hello to the customer based on the associate action data received from the electronic sensor.

In an embodiment, a system for tracking associate interaction with a customer may include an associate-customer interaction server receiving associate action data. The system may further include a mobile device, corresponding to an associate, transmitting the associate action data. The system may also include an electronic sensor, integrated with the mobile device, sensing associate action. The system may additionally include an electronically defined associate-customer interaction policy comprising criteria defining how the associate is to interact with a customer. Moreover, the system may include, a customer interaction electronic record, corresponding to the associate, storing credit assigned to the associate.

In an implementation, the associate-customer interaction server may determine, from the associate action data received from the electronic sensor via the mobile device, whether an interaction between an associate and a customer has been initiated and whether the associate acted in accordance with the electronically defined associate-customer interaction policy during the interaction. The associate-customer interaction server may assign credit to the customer interaction electronic record corresponding to the associate. The electronic sensor may be at least one of an accelerometer, a microphone, a video camera, an audio recorder, a Wi-Fi transceiver, a Bluetooth transceiver, an NFC transceiver, a GPS transceiver, and a telecommunications transceiver.

In an embodiment, a computer program product residing on a computer readable storage medium may have a plurality of instructions stored thereon, which, when executed by a processor, may cause the processor to perform operations for tracking associate interaction with a customer. The operations may include receiving, at an associate-customer interaction server, associate action data from an electronic sensor. The operations may further include determining, at the associate-customer interaction server and from the associate action data received from the electronic sensor, whether an interaction between an associate and a customer has been initiated. The operations may also include, in response to determining that the interaction between the associate and the customer has been initiated, determining, at the associate-customer interaction server, whether the associate acted in accordance with an electronically defined associate-customer interaction policy during the interaction based on the associate action data. The operations may additionally include, in response to determining that the associate acted in accordance with the electronically defined associate-customer interaction policy, assigning, via the associate-customer interaction server, credit to a customer interaction electronic record corresponding to the associate.

In an embodiment, a computing system for tracking associate interaction with a customer may include one or more processors. The one or more processors may be configured to receive, at an associate-customer interaction server, associate action data from an electronic sensor. The one or more processors may be further configured to determine, at the associate-customer interaction server and from the associate action data received from the electronic sensor, whether an interaction between an associate and a customer has been initiated. The one or more processors may also be configured to in response to determining that the interaction between the associate and the customer has been initiated, determine, at the associate-customer interaction server, whether the associate acted in accordance with an electronically defined associate-customer interaction policy during the interaction based on the associate action data. The one or more processors may additionally be configured to, in response to determining that the associate acted in accordance with the electronically defined associate-customer interaction policy, assign, via the associate-customer interaction server, credit to a customer interaction electronic record corresponding to the associate.

The details of one or more implementations are set forth in the accompanying drawings and the description below. Other features and advantages will become apparent from the description, the drawings, and the claims.

### BRIEF DESCRIPTION OF THE DRAWINGS

FIG. 1 depicts an example system that can execute implementations of the present disclosure;

FIG. 2 illustrates an example process for tracking associate interaction in accordance with the present disclosure; and

FIG. 3 depicts an example system for tracking associate interaction accordance with the present disclosure.

### DETAILED DESCRIPTION

### Overview

A retailer or other company or business may wish to understand how its employees or associates interact with customers. The retailer may further wish to understand whether or not its associates follow the retailer's policies while interacting with customers. For example, the retailer may wish to know if a particular associate had an interaction with a customer and, if so, whether or not the associate properly greeted the customer. Further, the retailer may wish to reward the associate for having interacted with and greeted with the customer in accordance with the retailer's policies.

Business leaders or managers may evaluate their employees or associates by physically monitoring them, witnessing their performance, and providing reports and feedback on the employees or associates in either written form or by entering the reports and feedback into a computer. Other approaches to evaluating employees or associates may include using video, voice, or audio in a live text manner to determine how an employee is interacting with a customer, however the video, voice, or audio in a live text may still need to be physically reviewed by a supervisor. Further, a business may ask a customer to fill out a survey to evaluate customer's experience with a particular employee, however, customers who have enjoyed their experience tend to be less likely to fill out surveys, leaving the employee with more band evaluations when compared to good evaluations. These approaches to evaluating employee or associate interaction with customers may not be automated or may not allow for seamlessly rewarding the employee or associate for positive interactions or interactions which comply with business policy. Thus, there may be a need for improving currently available approaches of evaluating of an employee's interaction with a customer of rewarding the employee for positive interactions or interactions which comply with business policy.

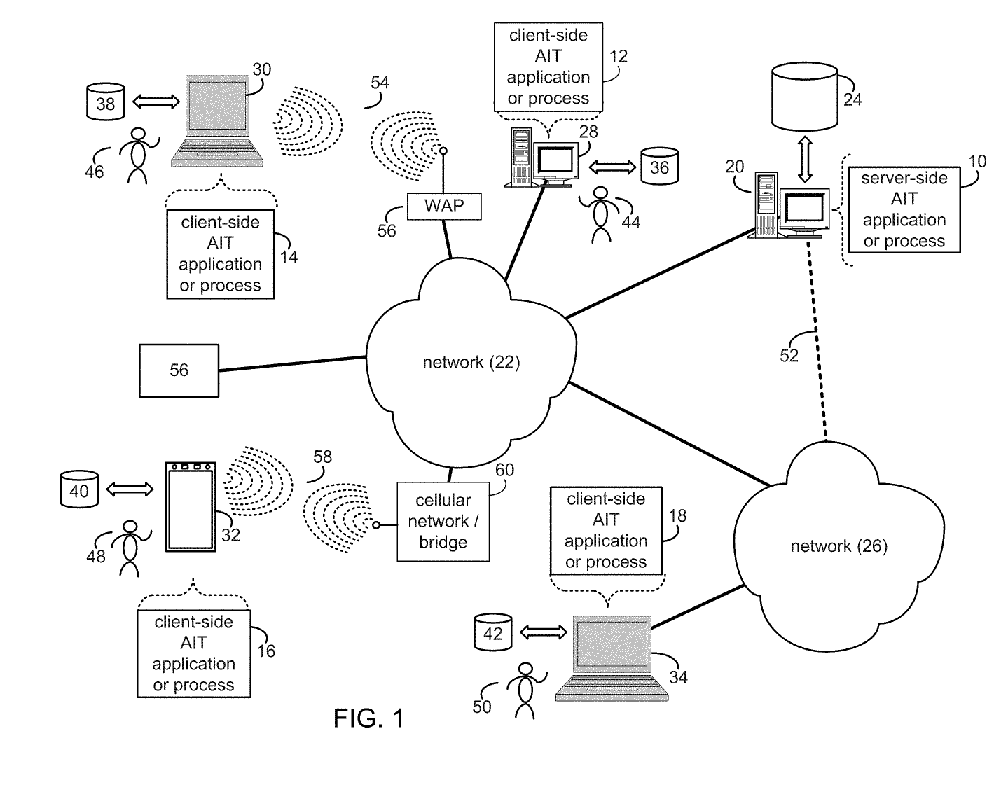

Referring to FIGS. 1 & 2, there is shown a server application 10 and client applications 12, 14, 16, and 18. Server application 10 and/or one or more of client applications 12, 14, 16, and/or 18 may execute one or more processes configured to carry out one or more of the features described herein. Server application 10 may be referred to as a process configured to carry out one or more of the features described herein, such as associate interaction tracking (AIT) process 10. Further, one or more of client applications 12, 14, 16, and 18 may be referred to as a process configured to carry out one or more of the features described herein, such as associate interaction tracking (AIT) processes 12, 14, 16, and/or 18.

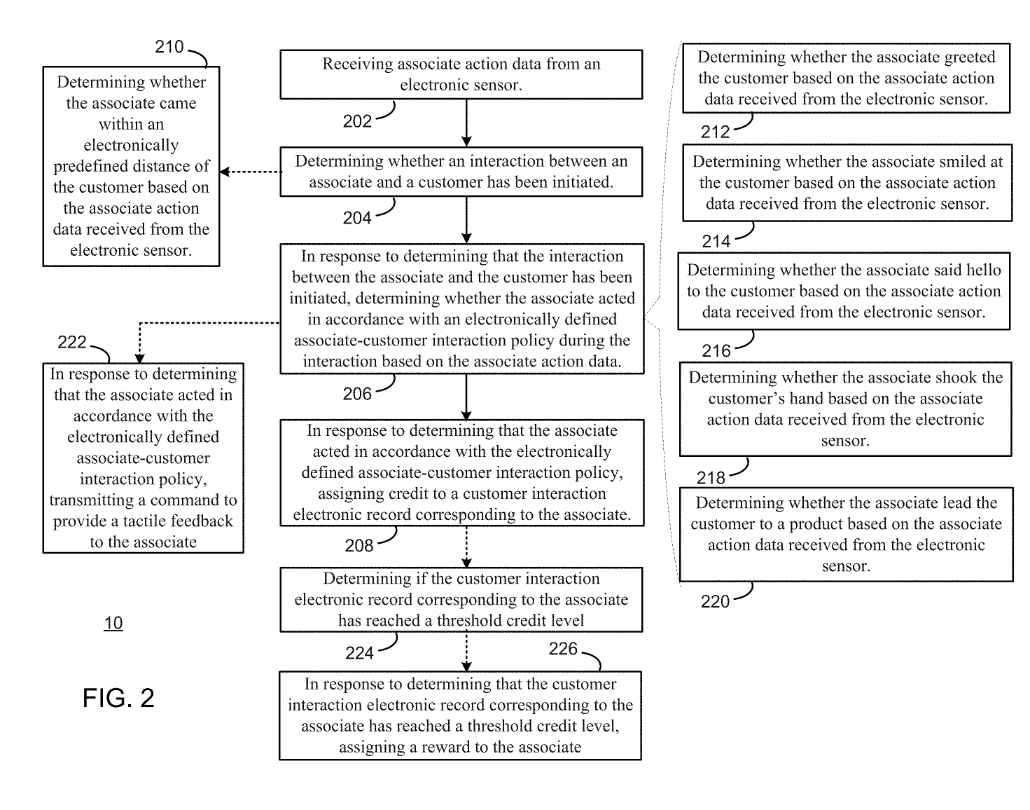

Referring now to FIG. 2, an example AIT process 10 is shown. AIT process 10 may include receiving (202) associate action data from an electronic sensor. AIT process 10 may further include determining (204) whether an interaction between an associate and a customer has been initiated. AIT process 10 may also include, in response to determining that the interaction between the associate and the customer has been initiated, determining (206) whether the associate acted in accordance with an electronically defined associate-customer interaction policy during the interaction based on the associate action data. AIT process 10 may additionally include, in response to determining that the associate acted in accordance with the electronically defined associate-customer interaction policy, assigning (208) credit to a customer interaction electronic record corresponding to the associate.

The AIT process may be a server-side process (e.g., server-side AIT process 10), a client-side process (e.g., client-side AIT process 12, client-side AIT process 14, client-side AIT process 16, or client-side AIT process 18), or a hybrid server-side/client-side process (e.g., a combination of server-side AIT process 10 and one or more of client-side AIT processes 12, 14, 16, 18).

### System Overview

Referring to FIG. 1, server-side AIT process 10 may reside on and may be executed by server computer 20, which may be in communication with network 22 (e.g., the Internet or a local area network). Examples of server computer 20 may include, but are not limited to: a personal computer, a server computer, a series of server computers, a mini computer, and/or a mainframe computer. The server computer 20 may be a distributed system and the operations of server computer 20 may execute on one or more processors, simultaneously and/or serially. For example, server computer 20 may be a symbolic representation of a cloud computing site, cloud environment, or cloud platform running multiple servers, computers, or virtual machines. Server computer 20 may execute one or more operating systems, examples of which may include but are not limited to: Microsoft Windows Server™; Novell Netware Redhat Linux™, Unix, or a custom operating system, for example.

In an implementation, server computer 20 may be an associate-customer interaction server which may include, store, run, and/or execute AIT process 10. The associate-customer interaction server may be part of a network of servers and other computing devices administered by a company or business that uses AIT process 10, such as a retailer or physical store having employees or associates.

The instruction sets and subroutines of server-side AIT process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a solid state storage device; a RAID array; a random access memory (RAM); and a read-only memory (ROM).

Server computer 20 may execute a web server application that allows for access to server computer 20 (via network 22) using one or more protocols, examples of which may include but are not limited to HTTP (i.e., HyperText Transfer Protocol). Network 22 may be in communication with one or more secondary networks (e.g., network 26), examples of which may include but are not limited to: a local area network; a wide area network; or an intranet, for example.

Client-side AIT processes 12, 14, 16, 18 may reside on and may be executed by client electronic devices 28, 30, 32, and/or 34 (respectively), examples of which may include but are not limited to personal computer 28, a television with one or more processors embedded therein or coupled thereto (not shown), laptop computer 30, data-enabled mobile telephone 32, notebook computer 34, a tablet (not shown), and a personal digital assistant (not shown), for example. Client electronic devices 28, 30, 32, and/or 34 may each be in communication with network 22 and/or network 26 and may each execute an operating system, examples of which may include but are not limited to Apple iOS™, Microsoft Windows™, Android™, Redhat Linux™, or a custom operating system.

In an implementation, one or more of client electronic devices 28, 30, 32, and/or 34 may be associated with an associate who is an employee of a company or business that uses one or more of AIT process 10, 12, 14, 16, and/or 18 such as a retailer or physical store having employees or associates. For example, data-enabled mobile telephone 32 may be a mobile device such as a smartphone associated with the associate.

The instruction sets and subroutines of client-side AIT processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; solid state storage devices; RAID arrays; random access memories (RAM); read-only memories (ROM); compact flash (CF) storage devices; secure digital (SD) storage devices; and memory stick storage devices.

Client-side AIT processes 12, 14, 16, 18 and/or server-side AIT process 10 may be processes that run within (i.e., are part of) a cloud computing site, cloud computing application, cloud platform, or cloud environment. Alternatively, client-side AIT processes 12, 14, 16, 18 and/or server-side AIT process 10 may be stand-alone applications that work in conjunction with the cloud computing site, cloud computing application, cloud platform, or cloud environment. One or more of client-side AIT processes 12, 14, 16, 18 and server-side AIT process 10 may interface with each other (via network 22 and/or network 26).

Users 44, 46, 48, 50 may access server-side AIT process 10 directly through the device on which the client-side AIT process (e.g., client-side AIT processes 12, 14, 16, 18) is executed, namely client electronic devices 28, 30, 32, 34, for example. Users 44, 46, 48, 50 may access server-side AIT process 10 directly through network 22 and/or through secondary network 26. Further, server computer 20 (i.e., the computer that executes server-side AIT process 10) may be in communication with network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing a wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

All of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth is a telecommunications industry specification that allows e.g., mobile phones, computers, and personal digital assistants to be interconnected using a short-range wireless connection.

### Associate Interaction Tracking (AIT) Process

For the following discussion, server-side AIT process 10 will be described for illustrative purposes. It should be noted that server-side AIT process 10 may interact with client-side AIT process 12 and may be executed within one or more applications that allow for communication with client-side AIT process 12. However, this is not intended to be a limitation of this disclosure, as other configurations are possible (e.g., stand-alone, client-side AIT processes and/or stand-alone server-side AIT processes). For example, some implementations may include one or more of client-side AIT processes 12, 14, 16, and/or 18 in place of or in addition to server-side AIT process 10.

Referring to FIGS. 1 and 2, in an embodiment, AIT process 10 may be a method for tracking associate interaction with a customer. AIT process 10 may receive (202) associate action data from an electronic sensor. The associate action data may be received from an electronic sensor at an associate-customer interaction server (e.g., server computer 20). The associate action data may be data from which conclusions about the associate's actions and/or performance can be drawn. For example, the associate action data may be used to determine one or more of identification, location, movement or speech of the associate, among other information.

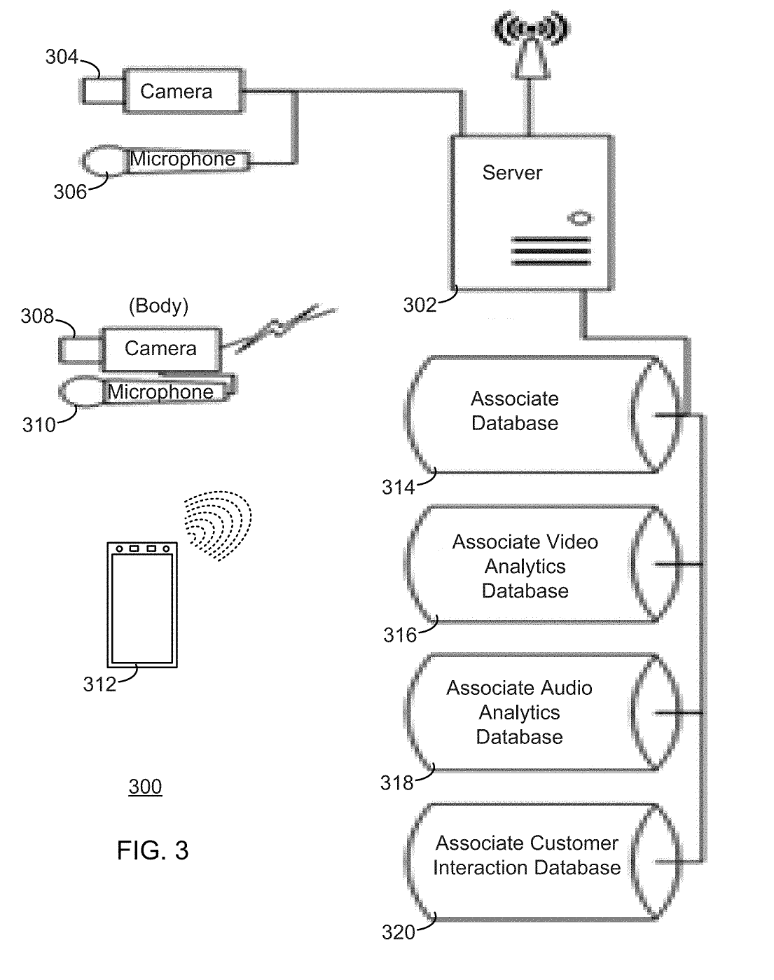

Referring now to also to FIG. 3, in an embodiment, a system 300 may track associate interaction with a customer. System 300 may include associate-customer interaction server 302. Associate-customer interaction server 302 may be a server which runs AIT process 10 and may be configured to receive associate action data from the electronic sensor. The electronic sensor may be one or more of wired camera 304, wired microphone 306 (either of which may be positioned around a retail store), wireless or body camera 308, wireless or body microphone 310, or one or more of a an accelerometer, a microphone, a video camera, an audio recorder, a Wi-Fi transceiver, a Bluetooth transceiver, an NFC transceiver, a GPS trans receiver, or other telecommunications transceiver integrated in mobile device 312. The electronic sensor may be a component of mobile device 12 which may correspond to the associate.

In an implementation, system 300 may include RFID equipment (not shown) including RFID scanners and RFID employee badges. The RFID equipment may be used to identify an employee or associate. Further, one or more cameras of system 300 may scan an employee badge and/or bar code in order to identify the employee or associate. The one or more cameras of system 300 may also provide associate action data which may be analyzed (i.e., video analytics) to identify the employee of associate. Additionally, a Wi-Fi signal associate with the associate's mobile device may be used to identify the associate. These and other techniques may be used to identify the associate via AIT process 10 so that the systems and methods for tracking associate interaction described herein can be applied.

In various implementations, and as discussed below, associate-customer interaction server 302 may be further configured to (e.g., by running AIT process 10 and/or one or more of AIT processes 12, 14, 16, and/or 18) determine, from the associate action data received from the electronic sensor, whether an interaction between an associate and a customer has been initiated. Associate-customer interaction server 302 may also be configured to, in response to determining that the interaction between the associate and the customer has been initiated, determine, from the associate action data received from the electronic sensor, whether the associate acted in accordance with an electronically defined associate-customer interaction policy during the interaction.

For example, associate-customer interaction server 302 may, while running AIT process 10, transmit associate action data to, receive associate action data from, or otherwise use one or more of associate database 314, associate video analytics database 316, associate audio analytics database 318, and/or associate customer interaction database 320 in determining whether the interaction between the associate and the customer has been initiated and determining whether the associate acted in accordance with an electronically defined associate-customer interaction policy during the interaction. For example, associate-customer interaction server 302 may receive associate action data from one or more of wired camera 304, wired microphone 306, wireless or body camera 308, wireless or body microphone 310, and mobile device 312 and transmit the associate action data to one or more of associate database 314, associate video analytics database 316, associate audio analytics database 318, and/or associate customer interaction database 320 for storage or analysis. In this way, associate action data may be collected and various audio, video and interaction data points may be stored in the various databases and retrieved and used by an analytics engine to carry out one or more of the techniques and features described in the present disclosure.

In an embodiment, system 300 may include mobile device 312. Mobile device 312 may correspond to an associate and may transmit associate action data to associate-customer interaction server 302. As discussed above, system 302 may include one or more electronic sensors which may be integrated with mobile device 312. The one or more electronic sensors integrated with mobile device 312 may sense associate action. For example, in an implementation, an associate working at a retail store may attach mobile device 312 to his or her arm. Mobile device 312 may include an accelerometer which senses associate action. Associate action data representative of the associate action sensed by the accelerometer may be transmitted to associate-customer interaction server 302 where it may be used to determine whether or not the associate shook a customer's hand after an associate-customer interaction was initiated.

Further, system 300 may additionally include an electronically defined associate-customer interaction policy which may include criteria defining how an associate is to interact with a customer. For example, the criteria defining how the associate is to interact with the customer may include criteria on proper voice modulation (i.e., to detect if the associate is using polite inflection in their voice when communicating with the customer) and response metrics to mobile alerts. System 300 may further include a customer interaction electronic record which may correspond to the associate and may store credit assigned to the associate.

In an implementation, and as discussed above the electronic sensor may be a stand-alone electronic sensor such as a wireless body camera or microphone worn by the associate, or a wired camera or microphone or series of wired and/or wireless cameras or microphones positioned around a retail store or business, or may be a component or integrated with a mobile device corresponding to the associate (e.g., one or more of client electronic devices 28, 30, 32, 34) such as a smartphone or tablet. Further, the electronic sensor may be an accelerometer, a microphone, a video camera, an audio recorder, a Wi-Fi transceiver, a Bluetooth transceiver, an NFC transceiver, a GPS transceiver, heat sensor (to detect body heat), proximity sensor (for detecting nearby customers) and/or a telecommunications transceiver, any of which can be used independently or together to detect associate-customer interaction data or to detect customers.

Referring back, to FIG. 2, AIT process 10 may determine (204) whether an interaction between an associate and a customer has been initiated. Whether an interaction between the associate and the customer has been initiated may be determined at the associate-customer interaction server (e.g., server computer 20) and may be based on the associate action data received from the electronic sensor. Further, determining (204) whether the interaction between the associate and the customer has been initiated may include determining (210) whether the associate came within an electronically predefined distance of the customer, based on the associate action data received from the electronic sensor.

For example, a retailer may have a 10 ft. rule or policy for its associates. Under this policy, if an associate comes within 10 ft. of a customer at the store, an interaction between the associate and the customer has been or should be initiated. In other words, once the associate-customer interaction server has determined that the associate has come within 10 ft. of the customer, the associate should proceed to act in accordance with a defined associate-customer interaction policy. Using the associate action data and various video, audio, and/or location-based analytics (among other types of analytics) at the associate-customer interaction server, AIT process 10 may determine if the associate came within 10 ft. of a customer (i.e., an interaction) and further determine whether the associate acted in accordance with an electronically defined associate-customer interaction policy.

In an implementation, a camera positioned in the retail store, a wireless or body camera worn by an associate, or a camera integrated with a mobile device carried by the associate may sense associate action and transmit associate action data representative of the associate action to the associate-customer interaction server where the associate action data may be used to determine a distance between the associate and a customer. For example, camera focal length may be used to determine the distance between the associate and the customer. In implementation, heat sensors may be used to determine nearby body heat to extrapolate the substance and proximity sensors may also be used. Further, in an implementation, the associate action data may be locationing information determined from a Wi-Fi connection established between a mobile device of an associate or a customer and a router positioned in the retail store. Using information on which router in a retail store a mobile device is connected to, AIT process 10 may determine if an associate-customer interaction has taken place. By detecting which router an associate (via, e.g., mobile device) is connected to, AIT process 10 may determine the associate's location in the store in relation to one or more customers (via, e.g., mobile device) connected to the same router.

Determining whether the interaction between the associate and the customer has been initiated may be based on location based-data from at least one of a mobile device corresponding to the associate and a mobile device corresponding to the customer. The location based-data may be based on a Wi-Fi connection of at least one of the mobile device corresponding to the associate and the mobile device corresponding to the customer. In an implementation, one or more of the electronic sensors described herein may feed a central algorithm or process, which may be part of AIT process 10, for example. The process may combine each data point and/or cross-reference each electronic sensor's data point to create a full picture. For example, a camera may provide image data, GPS, Wi-Fi, and/or Bluetooth devices may provide store location data, proximity and/or heat sensors may provide confirmation to the camera data that a customer was located nearby an associate. In this way, AIT process 10 may determine (210) whether the associate came within an electronically predefined distance of the customer based on the associate action data received from the electronic sensor. Microphone and/or camera data may be used to determine how the associate responded to the customer.

In an implementation, determining whether the interaction between the associate and the customer has been initiated may include determining whether the associate deviated from an electronically defined associate task list. Determining whether the associate deviated from the electronically defined associate task list may be based on the associate action data received from the electronic sensor. Further, determining whether the associate deviated from the electronically defined associate task list may include determining whether the associate left a particular area associated with the electronically defined associate task list based on the associate action data received from the electronic sensor. Using the associate action data and various video, audio, and/or location-based analytics (among other types of analytics) at the associate-customer interaction server, AIT process 10 may determine whether the associate deviated from an electronically defined associate task list and/or left a particular area associated with the electronically defined associate task list, and further determine whether the associate acted in accordance with the electronically defined associate-customer interaction policy. For example, if an associate is in a certain area of a retail store that corresponds to an item on the associate's task list, a customer enters that area, and the associate leaves that area, it may be assumed that the associate left the area (i.e., deviated from the task list and initiated an interaction) to help the customer in a different area of the (e.g., to find merchandise in the different area). In an implementation, AIT process 10 may use predefined associate task lists (which may include what each task is and the location of the store in which each task is to be completed in) and an external alerting system output (e.g., data from one or more of the electronic sensors) as data inputs. AIT process 10 may cross-tabulate the associate task lists with associate locations as determined by the one or more electronic sensors to determine if and when an associate leaves an area without signing off (e.g., as completed) on the task at hand.

AIT process 10 may, in response to determining that the interaction between the associate and the customer has been initiated, determine (206), (e.g., at the associate-customer interaction server), whether the associate acted in accordance with an electronically defined associate-customer interaction policy during the interaction. Determining (206) whether the associate acted in accordance with an electronically defined associate-customer interaction policy during the interaction may be based on the associate action data. For example, under the electronically defined associate-customer interaction policy, the associate may be required to smile or otherwise greet the customer once the associate comes within 10 ft. of the customer.

In order to determine whether the associate acted in accordance with the electronically defined associate-customer interaction policy during the interaction, AIT process 10 may determine (212) whether the associate greeted the customer based on the associate action data received from the electronic sensor. Using the associate action data and various video, audio, and/or location-based analytics (among other types of analytics) at the associate-customer interaction server, AIT process 10 may determine (212) whether the associated greeted the customer and further determine whether the associate acted in accordance with the electronically defined associate-customer interaction policy.

For example, the electronically defined associate-customer interaction policy may require that once the associate is within the predefined distance (e.g., (10 ft.) of the customer, the associate must greet the customer by doing one or more of smiling at the customer, saying hello to the customer, shaking the customer's hand, and/or leading the customer to a product. In an implementation, AIT process 10 may determine (214) whether the associate smiled at the customer based on the associate action data received from the electronic sensor. Using the associate action data and various video, audio, and/or location-based analytics (among other types of analytics) at the associate-customer interaction server, AIT process 10 may determine (214) whether the associated smiled at the customer and further determine whether the associate acted in accordance with the electronically defined associate-customer interaction policy. In implementation, electronic sensor data (e.g., camera data) from the retail store (i.e., from an associate mobile device or other camera in the store) may be sent to a facial recognition algorithm or process which may be part of AIT process 10. The facial recognition algorithm or process may determine if the associate is smiling. Cross-tabulated microphone data corresponding to the associate may then be then algorithmically analyzed (e.g., via AIT process 10) for voice inflection, tone, and/or speech pattern to determine if the associate was speaking politely to the customer. A speech recognition algorithm or process which may be part of AIT process 10 may detect if the customer said one or more expected catch words or phrases (e.g., “How may I help you?”, etc.).

Further, in an implementation, AIT process 10 may determine (216) whether the associate said hello to the customer based on the associate action data received from the electronic sensor. Using the associate action data and various video, audio, and/or location-based analytics (among other types of analytics) at the associate-customer interaction server, and/or one or more of the techniques and features described above, AIT process 10 may determine (216) whether the associate said hello to the customer and further determine whether the associate acted in accordance with the electronically defined associate-customer interaction policy.

In an implementation, one or more microphones may be used to collect audio data, which may be analyzed to determine if a greeting or offer of help was made by the associate. The one or more microphones may be used for noise cancelling, isolating voices of interest, and determining a direction of sound in order to determine who the associate was speaking with. Various analytics and algorithms may be used to determine if an associate-customer interaction was positive, how long the associate-customer interaction was, how loud the associate's speech and/or greeting was, etc. Speech recognition and other algorithms may be uses to detect what was said and voice inflection. For example, spectral analysis may be used to detect pitch fluctuations in voices to determine whether the interaction was positive. Preloaded data sets representing positive or negative speech patterns may be used to analyze whether the associate or customer's greeting was positive (e.g., did they say “hello” or another greeting in a positive way?).

In an implementation, audio data collected from the one or more microphones may also be used to determine a distance between an associate and a customer. For example, when a customer responds to an associate, a direction and distance from the customer to the associate may be determined from the audio data. An associate may wear a headset having one or more microphones (e.g., two in the front and two in the back) and AIT process 10 may use speed of sound and various analytics to determine when each microphone picks up speech from the customer. This information may be used to estimate the distance between the associate and the customer. Various proximity sensors may be worn by the associate on a vest or headset and data received from the proximity sensors may also be used to determine a distance between the associate and the customer.

Further, in an implementation, AIT process 10 may determine whether the associate acted in accordance with the electronically defined associate-customer interaction policy during the interaction by determining (218) whether the associate shook the customer's hand. Determining (218) whether the associate shook the customer's hand may be based on the associate action data received from the electronic sensor. For example, AIT process 10 may use the associate action data, and various video, audio, and/or location-based analytics (among other types of analytics at the associate-customer interaction server to determine (218) whether the associate shook the customer's hand and further determine whether the associate acted in accordance with the electronically defined associate-customer interaction policy.

In an implementations, AIT process 10 may use one or more body cameras worn by an associate (e.g., on a vest). Associate action data may be received from the body cameras and may represent a skeletal image of the associate's body or the customer's body. In particular, skeletal images of the arms, wrists, and/or hands of the associate and a person approaching the associate (e.g., a customer) may be used by various analytics and algorithms to detect if the arms, wrists, and/or hands of the associate and the customer join, move up or down, or otherwise move to indicate that a handshake occurred. Associate action data corresponding to the skeletal images of the arms, wrists, and/or hands of the associate and/or customer may be analyzed to determine if, for example, the arms, wrists, and/or hands moves up and/or down relative to a y-axis with different degrees of speed to determine if the handshake occurred, if the handshake was a relatively long or big or small hand shake, if the right hand was used, etc. An application program interface may receive the data from the one or more body cameras, and use the data to build the skeletal models and analyze the data for interaction of two hands and movement. The data from the camera may or may not be stored, but may be analyzed in real time or near real time to detect a handshake and log that the handshake took place. In an implementation, details about the hand (e.g., handshake time length, how vigorous the handshake was, handshake velocity, etc.) may be stored.

Further, in an implementation, AIT process 10 may determine whether the associate acted in accordance with the electronically defined associate-customer interaction policy during the interaction by determining (220) whether the associate lead the customer to a product. Determining (220) whether the associate lead the customer to a product may be based on the associate action data received from the electronic sensor. For example, AIT process 10 may use the associate action data and various video, audio, and/or location-based analytics (among other types of analytics at the associate-customer interaction server) to determine (220) whether the associate lead the customer to a product and further determine whether the associate acted in accordance with the electronically defined associate-customer interaction policy. In an implementation, GPS, Wi-Fi, and/or Bluetooth devices may be used for location-tracking to determine whether the associate lead the customer to a product. Additionally, associate body cameras, store cameras, and/or microphone data may be used to determine an associate's movement about a store and whether the associate lead the customer to a product. Further, a speech recognition algorithm or process, which may be part of AIT process 10, may recognize product descriptions given by a customer and may cross-tabulate that a product description with product location data in a store item location database to confirm whether the associate led the customer to a correct location for a detected product.

In certain circumstances, upon determining whether the associate acted in accordance with the electronically defined associate-customer interaction policy, the retailer may wish to give the associate credit or otherwise reward the associate for acting in accordance with the electronically defined associate-customer interaction policy. For example, AIT process 10 may, in response to determining that the associate acted in accordance with the electronically defined associate-customer interaction policy, assign (208) (e.g., via the associate-customer interaction server) credit to a customer interaction electronic record corresponding to the associate. The customer interaction electronic record corresponding to the associate may reside at the associate-customer interaction server. In this way, AIT process 10 may track merits or achievements of associates and provide an incentive for associate performance as determined appropriate by one or more system administrators. The one or more system administrators may set levels of priority for specific events or merits such as proper greeting, handshaking, smiling, helping, task completion, etc. For example, smiling at a customer may be worth a 10 point credit, and when an associate collects 100 points, they may receive a day off or other rewards.

In an implementation, AIT process 10 may determine (224) if the customer interaction electronic record corresponding to the associate has reached a threshold credit level. For example, AIT process 10 may determine (224) if the customer interaction electronic record corresponding to the associate has reached a threshold credit level using one or more operations at the associate-customer interaction server. The customer electronic record may store, for example, a number of points or other units or credits assigned or awarded to the associate each time the associate acts in accordance with the electronically defined associate-customer interaction policy. The number of points or other units or credits assigned or awarded to the associate may be set by the one or more system administrators via AIT process 10.

Further, in response to determining that the customer interaction electronic record corresponding to the associate has reached the threshold credit level, AIT process 10 may assign (226) a reward to the associate. For example, AIT process 10 may assign (226) a reward to the associate using one or more operations at the associate-customer interaction server. The reward may be determined based on an electronically defined table or scale in which one or more values for a threshold credit level correspond to various rewards for associates. Further, as described above, the reward may be defined electronically by one or more supervisors or administrators of the associate-customer interaction server.

Further, AIT process 10 may, in response to determining that the associate acted in accordance with the electronically defined associate-customer interaction policy, transmit (222) a command to provide a tactile feedback to the associate. The command to provide tactile feedback to the associate may be transmitted from the associate-customer interaction server to the mobile device corresponding to the associate. For example, the command to provide the tactile feedback to the associate may be a command to actuate a vibration in the mobile device corresponding to the associate. In an implementation, the command to provide the tactile feedback to the associate may also be a command to display a notification or play a sound or alarm at the mobile device corresponding to the associate.

As described above, the techniques and features described in the present disclosure may facilitate a retailer or other company or business in rewarding associates who provide customer contact and support. Using the techniques and features described in the present disclosure, the retailer may implement an associate-customer interaction policy and encourage associates to follow the policy to increase the quality of associate contact with and support of customers.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the disclosure can be realized as one or more computer program products, i.e., one or more modules of computer program instructions encoded on a computer readable medium for execution by, or to control the operation of, a data processing apparatus. The computer readable medium can be a machine-readable storage device, a machine readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions or computer program products and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These may also be referred to as computer readable storage media. The processor and the memory can be supplemented by, or incorporated in, special purpose logic circuitry.

To provide for interaction with a user, implementations of described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the present disclosure can be realized in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

A number of embodiments and implementations have been described. Nevertheless, it will be understood that various modifications may be made. Accordingly, other embodiments and implementations are within the scope of the following claims. For example, the actions recited in the claims can be performed in a different order and still achieve desirable results.

What is claimed is:

1. A method for tracking associate interaction with a customer, the method comprising:
receiving, at an associate-customer interaction server, associate action data from an electronic sensor;
determining, at the associate-customer interaction server and from the associate action data received from the electronic sensor, whether an interaction between an associate and a customer has been initiated;
in response to determining that the interaction between the associate and the customer has been initiated, determining, at the associate-customer interaction server, whether the associate acted in accordance with an electronically defined associate-customer interaction policy during the interaction based on the associate action data;
in response to determining that the associate acted in accordance with the electronically defined associate-customer interaction policy, assigning, via the associate-customer interaction server, credit to a customer interaction electronic record corresponding to the associate; and
in response to determining that the associate acted in accordance with the electronically defined associate-customer interaction policy, transmitting a command to provide a tactile feedback to the associate

2. The method of claim 1, wherein the electronic sensor is a component of a mobile device corresponding to the associate.

3. The method of claim 1, wherein the electronic sensor is at least one of an accelerometer, a microphone, a video camera, an audio recorder, a Wi-Fi transceiver, a Bluetooth transceiver, an NFC transceiver, a GPS transceiver, and a telecommunications transceiver.

4. The method of claim 1, wherein determining whether the interaction between the associate and the customer has been initiated further comprises:
determining whether the associate came within an electronically predefined distance of the customer based on the associate action data received from the electronic sensor.

5. The method of claim 1, wherein determining whether the associate acted in accordance with the electronically defined associate-customer interaction policy during the interaction further comprises at least one of:
determining whether the associate greeted the customer based on the associate action data received from the electronic sensor;
determining whether the associate smiled at the customer based on the associate action data received from the electronic sensor; and
determining whether the associate said hello to the customer based on the associate action data received from the electronic sensor.

6. The method of claim 1, wherein determining whether the associate acted in accordance with the electronically defined associate-customer interaction policy during the interaction further comprises:
determining whether the associate shook the customer's hand based on the associate action data received from the electronic sensor.

7. The method of claim 1, wherein determining whether the associate acted in accordance with the electronically defined associate-customer interaction policy during the interaction further comprises:
determining whether the associate lead the customer to a product based on the associate action data received from the electronic sensor.

8. The method of claim 1, wherein determining whether the interaction between the associate and the customer has been initiated further comprises at least one of:
determining whether the associate deviated from an electronically defined associate task list based on the associate action data received from the electronic sensor; and
determining whether the associate left a particular area associated with the electronically defined associate task list based on the associate action data received from the electronic sensor.

9. The method of claim 1, further comprising:
determining if the customer interaction electronic record corresponding to the associate has reached a threshold credit level; and
in response to determining that the customer interaction electronic record corresponding to the associate has reached a threshold credit level, assigning a reward to the associate.

10. The method of claim 1, wherein the command to provide the tactile feedback to the associate is a command to actuate a vibration in a mobile device corresponding to the associate.

11. The method of claim 1, wherein determining whether the interaction between the associate and the customer has been initiated is based on location based-data from at least one of a mobile device corresponding to the associate and a mobile device corresponding to the customer.

12. The method of claim 11, wherein the location based-data is based on a Wi-Fi connection of at least one of the mobile device corresponding to the associate and the mobile device corresponding to the customer.

13. A system for tracking associate interaction with a customer, the system comprising:
an associate-customer interaction server configured to:
receive associate action data from an electronic sensor;
determine, from the associate action data received from the electronic sensor, whether an interaction between an associate and a customer has been initiated;
in response to determining that the interaction between the associate and the customer has been initiated, determine, from the associate action data received from the electronic sensor, whether the associate acted in accordance with an electronically defined associate-customer interaction policy during the interaction;
in response to determining that the associate acted in accordance with the electronically defined associate-customer interaction policy, assign credit to a customer interaction electronic record corresponding to the associate; and
in response to determining that the associate acted in accordance with the electronically defined associate-customer interaction policy, transmitting a command to provide a tactile feedback to the associate.

14. The system of claim 13, wherein the electronic sensor is a component of a mobile device corresponding to the associate.

15. The system of claim 13, wherein the electronic sensor is at least one of an accelerometer, a microphone, a video camera, an audio recorder, a Wi-Fi transceiver, a Bluetooth transceiver, an NFC transceiver, a GPS trans receiver, and a telecommunications transceiver.

16. The system of claim 13, wherein the associate-customer interaction server is further configured to:
determine whether the associate came within an electronically predefined distance of the customer based on the associate action data received from the electronic sensor.

17. The system of claim 13, wherein the associate-customer interaction server is further configured to:
determine whether the associate greeted the customer based on the associate action data received from the electronic sensor;
determine whether the associate smiled at the customer based on the associate action data received from the electronic sensor; and
determine whether the associate said hello to the customer based on the associate action data received from the electronic sensor.

18. The system of claim 13, wherein the command to provide the tactile feedback to the associate is a command to actuate a vibration in a mobile device corresponding to the associate.

19. A system for tracking associate interaction with a customer, the system comprising:
an associate-customer interaction server receiving associate action data;
a mobile device, corresponding to an associate, transmitting the associate action data;
an electronic sensor, integrated with the mobile device, sensing associate action;
an electronically defined associate-customer interaction policy comprising criteria defining how the associate is to interact with a customer; and
a customer interaction electronic record, corresponding to the associate, storing credit assigned to the associate;
wherein the associate-customer interaction server determines, from the associate action data received from the electronic sensor via the mobile device, whether an interaction between an associate and a customer has been initiated and whether the associate acted in accordance with the electronically defined associate-customer interaction policy during the interaction, assigns credit to the customer interaction electronic record corresponding to the associate, and transmits a command to provide a tactile feedback to the associate wherein the command to provide the tactile feedback to the associate is a command to actuate a vibration in a mobile device corresponding to the associate.

20. The system of claim 19, wherein the electronic sensor is at least one of an accelerometer, a microphone, a video camera, an audio recorder, a Wi-Fi transceiver, a Bluetooth transceiver, an NFC transceiver, a GPS trans receiver, and a telecommunications transceiver.
